(19) United States
(12) Patent Application Publication
(10) Pub. No.: US 2008/0221928 A1
(43) Pub. Date: Sep. 11, 2008

(54) System for Monitoring Patient Activity in a Medical Facility

(76) Inventors: Luis Garcia, Slinger, WI (US); Bryan D. Dickerson, Hartford, WI (US); Michael D. Cook, Watertown, WI (US); Nathan A. Schleifer, Grafton, WI (US); Jeffrey H. Peterson, Jackson, WI (US)

Correspondence Address: QUARLES & BRADY LLP, 411 E. WISCONSIN AVENUE, SUITE 2040, MILWAUKEE, WI, 53202-4497, US

(21) Appl. No.: 11/682,383

(22) Filed: Mar. 6, 2007

(51) Int. Cl. G06F 19/00

(52) U.S. Cl. 705/3

(57) ABSTRACT

A medical patient is issued an identification device that emits a first wireless signal providing a patient identification. A plurality of data collectors are placed at different locations in a medical facility to receive the first wireless signal when the patient is nearby. A separate patient event record is generated whenever one of the data collectors receives the first wireless signal and each such record contains the patient identification, time of receipt, and identification of the receiving data collector. The plurality of patient event records are analyzed to derive a report about activity of the patient within the medical facility. For example the report may indicate bathroom activity of the patient or how far and often the patient walked around the medical facility. The reports are useful to monitor and evaluate the patient's medical condition, recovery and security.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to systems for monitoring patients in a medical facility, and more particularly to a wireless system that automatically tracks activity of the patient.

2. Description of the Related Art

Patients in a hospital, an outpatient surgical center, an extended care facility, a nursing home, and other types of medical facilities are monitored by nursing personnel. In addition to recording a patient's vital signs, the ambulatory activity of the patient also is monitored. For example the number of times that a patient goes to the bathroom is observed as an indication of that bodily function. Orthopedic and other types of patients are prescribed to walk a certain amount at various times of the day as part of their rehabilitation and such activity also is monitored.

Observing activity of a patient consumes a considerable amount of personnel time. Some of the activity of a particular patient may be missed while the assigned nurse is attending to other patients.

Therefore, it is desirable to provide a system that automatically detects activity of a patient and enters information about the activity in the records for that person.

### SUMMARY OF THE INVENTION

A method for monitoring activity of a patient in a medical facility comprises issuing an identification device to the patient wherein the identification device emits a first wireless signal that identifies the patient. At least one data collector is placed at a location in the medical facility at which activity of the patient is desired to be monitored. Preferably data collectors are placed throughout areas of the medical facility where patients may travel. Each data collector receives the first wireless signal, and a separate patient event record is produced for each time that the first wireless signal is received. The patient event record may contain an identification of the patient and the time that the first wireless signal was received. When a plurality of data collectors are used, each patient event record indicates the particular data collector that received the first wireless signal on that occasion.

The patient event records generated in this manner are utilized to provide information about the motion activity of the associated patient. For example, the patient event record may indicate every time that the patient visits a bathroom, thereby providing information about those bodily functions. In another situation, the patient event record indicate how often the patient walks around the medical facility as part of an exercise or physical therapy regimen. Using patient event records from several data collectors, information can be derived designating the distance and rate that the patient walks.

The patient identification device optionally may be connected to apparatus carried by the patient which measure vital signs, such as temperature and heart rate, for example. This information is subsequently transmitted from the patient identification device to a centralized system for recordkeeping and diagnostic purposes.

This method enables the activity of medical patients to be automatically monitored for assessment of their medical conditions and recoveries without requiring observation of the activity by medical personnel.

### BRIEF DESCRIPTION OF THE DRAWINGS

FIG. 1 is a schematic diagram of a medical facility's computer system which stores information related to patients;

FIG. 2 depicts a room of the medical facility, wherein an electronic identification device worn by a patient transmits a wireless signal to a data collector;

FIG. 3 is a block schematic diagram of the electronic identification device;

FIG. 4 is a block schematic diagram of the data collector;

FIG. 5 is a diagram of rooms on part of a floor in the medical facility in which a patient monitoring system has been installed;

FIG. 6 is a graphical representation of data fields of a patient event record stored within the computer system;

FIG. 7 is a schematic diagram of another embodiment of an electronic identification device worn by the patient; and

FIG. 8 graphically depicts an exemplary signal produced by an accelerometer connected to the electronic identification device worn by a patient.

### DETAILED DESCRIPTION OF THE INVENTION

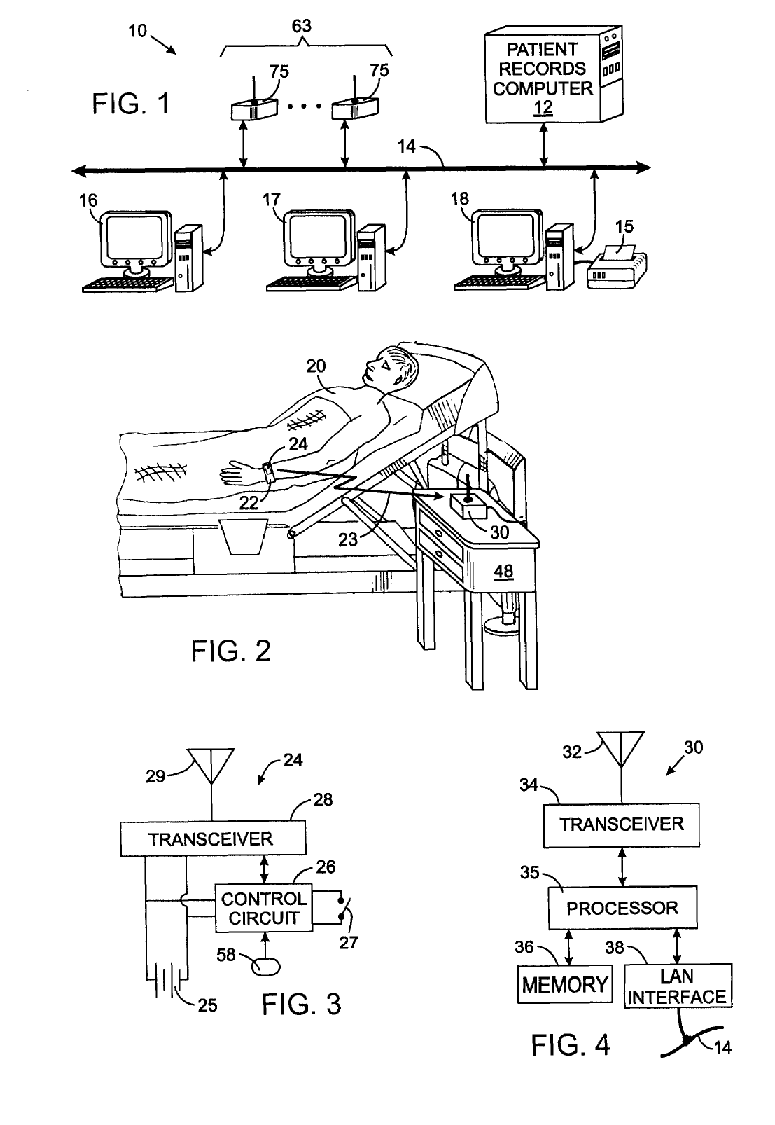

FIG. 1 illustrates a computer system 10 of a medical facility, such as a hospital, a clinic, a nursing home or an extended care facility, for example. The computer system 10 includes a computer 12, that processes and stores patient records and which is connected to a local area network (LAN) 14 of a type commonly found in work places. A plurality of personal computers 16, 17 and 18 are connected to the local area network 14 to exchange data and commands with the patient records computer 12 using a communication protocol. It should be understood that many more personal computers than are illustrated are connected to the LAN 14 throughout the medical facility. For example, personal computers are located at nursing stations, treatment areas, and administrative offices.

When a patient enters the medical facility, an admissions office worker inputs information into the patient records computer 12 via one of the personal computers 18. This process creates a record, for this visit of the patient, that contains standard information, such as the patient's name, address, biographical information, billing information, physicians' names and the like. As is conventional practice in most medical facilities, the personal computer prints a label 15 for a wristband that is worn by the patient to provide identification of this patient to healthcare workers.

However, unlike prior practice, the label 15 now is attached to a wristband 22 that contains an electronic identification device 24, which emits a radio frequency signal 23 carrying a unique identifier for this patient 20, as represented in FIG. 2. That patient identifier may comprise only numerals (i.e. a patient ID number), only alphabetic characters, or a combination of alphanumeric characters, as well as other characters. Although the exemplary identification device 24 is being described as attached to a wristband 22 fastened around the lower forearm of the patient 20, it should be understood that the identification device may be worn about other parts of the patient's body or clothing. The identification device 24 may be disposable along with the wristband 22. Alternatively, the identification device 24 may be removed from a wristband 22 upon a patient being discharged from the medical facility and then sterilized for reuse with another wristband for a different patient.

The identification device 24 may be programmed by the manufacturer with the patient identifier that may be the same as or different than the usual identification number assigned to patients upon admission. That identification number also is imprinted in human readable form on the wristband, so that it can be entered into the personal computer 18 and stored in a data file in the patient records computer 12 for this patient. Although the patient identifier is programmed into the patient identification device by the manufacturer, since that device is issued to a single patient, the patient identifier designates that specific patient. In some cases, the identification device 24 may be reusable with other patients, however at any point in time that device is issued to only one patient and thus the patient identifier designates only one patient at a time. Alternatively, the patient identifier may be programmed into the identification device 24 by the personal computer 18 in the admissions office. In that latter case, the personal computer may also download other information about the patient, such as allergies, into the patient identification device.

With reference to FIG. 3, the patient identification device 24 in the wristband 22 has a control circuit 26 which governs the operation of the device and has the unique patient identifier stored therein. A switch 27, connected to the control circuit, is used to activate the identification device upon being issued to a patient. When activated, the control circuit 26 periodically sends the patient identifier to a radio frequency (RF) transceiver 28 which thereby becomes activated. The transceiver 28 modulates an RF carrier with the patient identifier using any standard modulation technique. The resultant first radio frequency signal is applied to an antenna 29 from which the signal radiates in an omnidirectional pattern. The components of the identification device 24 are powered by a battery 25 or other electrical supply.

Referring again to FIG. 2, an activated identification device 24 periodically transmits the first radio frequency (RF) signal 23 containing the associated patient identifier. Alternatively, the patient identification device 24 transmits the first radio frequency signal only after receiving a second radio frequency signal from an interrogator, as will be described. This latter approach is more energy efficient as the transceiver 28 in a receive mode consumes less power than when transmitting. In both versions, the first RF signal from the patient's identification device 24 has an effective signal strength within only a few feet, e.g. eight to ten feet, around the patient 20 and may be blocked by room walls.

Other information stored in the patient identification device 24 also is transmitted to the medical facility computer system 10 along with the patient identifier. For example, data indicating restrictions on where within the medical facility the patient is permitted to walk can be entered into the device. The patient identification device 24 also may be connected to other apparatus carried by the patient which measure vital signs such as temperature and heart rate, for example. That data is periodically transmitted with the first RF signal 23. Even though the range of the first RF signal 23 is relatively small, each patient identification device 24 uses a different fixed transmission interval or varies its transmission interval to avoid collisions with the signals from other patient identification devices. Such conventional signal collision avoidance techniques also enable the use of a stronger signal with a greater range.

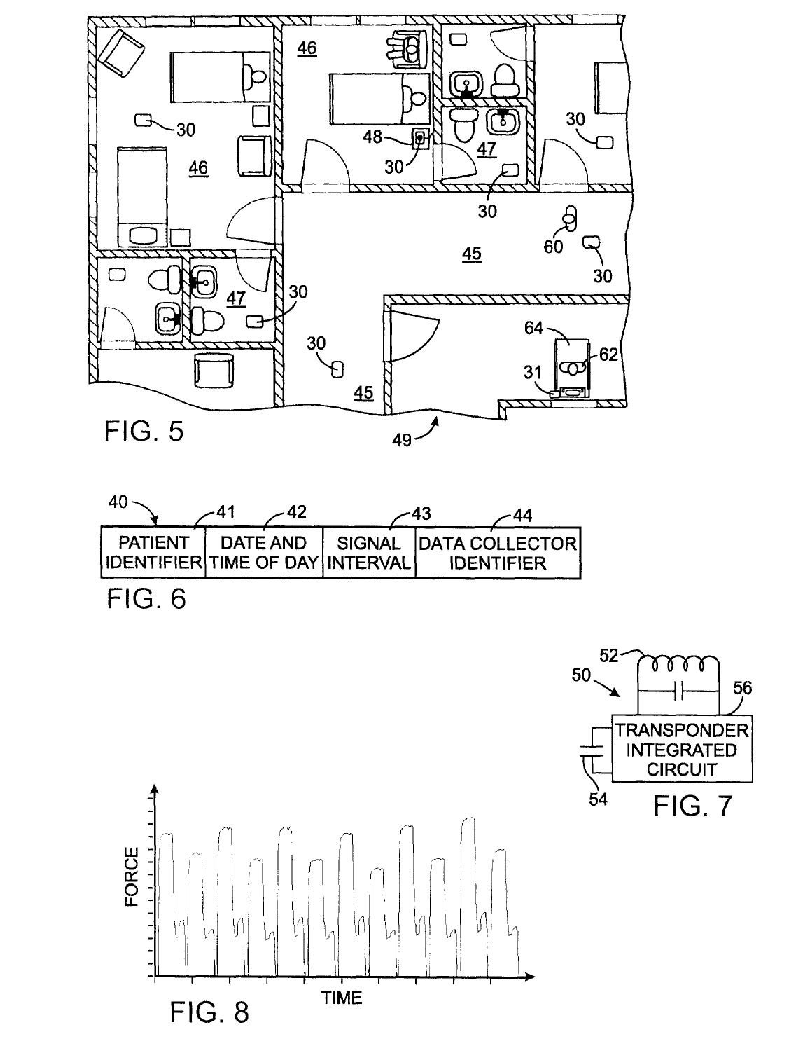

The data stored in the patient identification device 24 are transferred via the first RF signal to the computer system 10 via a plurality of wireless data collectors 30 located throughout the medical facility. As seen in FIG. 5, the data collectors 30 are located on the ceiling in patient rooms 46 and bathrooms 47, and at regular distances along the halls 45. Data collectors 30 also are placed in other areas of the medical facility 49 where patients may be present. As an alternative to ceiling placement, a data collector 30 can be located adjacent a patient's bed, such as on a table 48 as shown in FIG. 2.

With reference to FIG. 4, each data collector 30 has an antenna 32 connected to a transceiver 34 which exchanges commands and data with a processor 35, such as a microcomputer, for example. The data gathered by the data collector is stored temporarily by the processor 35 in a memory 36 along with the date and time of day that the respective signal from the patient identification device 24 was received.

Upon the receipt of the first RF signal 23 by the data collector 30, its processor 35 starts a software based timer which measures the interval at which the patient is in the vicinity of that data collector, referred to herein as a “signal interval”. That timer continues to run as long as the data collector 30 continues to receive periodically a first radio frequency signal 23 containing the same patient identifier. Since the patient identification device 24 transmits the first radio frequency signal at predetermined intervals, if a defined number of those intervals pass without receiving a radio frequency signal, the processor 35 concludes that a patient has moved away. Upon reaching that conclusion, the processor terminates the timer and stores the timer's final value (the signal interval) into a location in memory 36 that is associated with the most recently stored patient identifier. Thus, the memory 36 now contains a patient data set comprising an indication of the patient, the date and time of day, and the amount of time that the patient was near the respective data collector. The determination that the patient no longer is near the data collector is based on ceasing to receive the first radio frequency signal, which in the case of a periodically transmitted, or pulsed, signal is not merely when no signal is received, as that occurs between pulses, but rather when a pulse is not received for a given amount of time that is longer than the pulse cycle.

Occasionally, the acquired data and an identification of the particular data collector 30 are transferred as a patient event record to the patient records computer 12 via a LAN interface 38 connected to the local area network 14. An exemplary patient event record 40 is graphically depicted in FIG. 6. Each such record 40 comprises a first field 41 containing the patient identifier, a second field 42 with a date and time of day, and a third field 43 containing the signal interval, and a fourth field 44 which holds an identifier of the particular data collector 30. Other fields may be provided for additional types of data, such as patient vital signs. After all the patient event records have been transferred, that data is erased from the memory 36 of that data collector 30. The patient records computer 12 stores the received patient event record 40 for further analysis, as will be described.

As noted previously, an alternative patient identification device 24 may transmit its patient identifier only upon receiving a second radio frequency signal. In this case, each data collector 30 periodically, e.g. every second or two, transmits the second radio frequency signal and then waits for a reply from any nearby patient identification devices 24. Upon receiving the second radio frequency signal, the transceiver 28 in a patient identification device 24 signals its control circuit 26. The control circuit responds after a predefined interval by activating the transceiver 28 to send the patient identifier and any other data on the first radio frequency signal. Each patient identification device 24 waits different predefined interval before responding to avoid collisions with the signals from other patient identification devices.

That response signal is received by the data collector 30 and the data there from is stored in memory 36. As described previously that acquired data is thereafter transferred to the patient records computer 12 as a received patient event record 40.

FIG. 7 illustrates another type of electronic patient identification device 50 for incorporation into the wristband 22 of the patient 20. This latter patient identification device is passive in that it does not require a power source, such as a battery. Instead, the second patient identification device 50 comprises a conventional radio frequency transponder tag, such as the type that is commonly used to identify merchandise or used in a key-card of a building entry system. The second patient identification device 50 has an antenna 52 connected to a transponder integrated circuit 54 to form a resonant circuit tuned to the second radio frequency. The transponder integrated circuit 54 which may be any one of a number of commercially available devices, such one available from Texas Instruments Incorporated of Dallas, Tex., USA. The transponder integrated circuit 54 is powered by energy derived from a radio frequency signal received at antenna and stored in a capacitor 56. Because the second patient identification device 50 does not require power from a battery, it can be utilized with patients requiring long term care or who will be permanent residents of a nursing facility.

For the second patient identification device 50, each data collector 30, shown in FIG. 4, periodically transmits the second radio frequency signal that has an effective omnidirectional range of approximately ten feet, for example. Thus the signal range of one data collector may or may not overlap with another data collector's signal range. When a second patient identification device 50 is within that range, the transponder integrated circuit 37 becomes energized by power derived from the second radio frequency signal. After being powered for a predefined interval, the second patient identification device 50 replies by emitting the first radio frequency signal carrying the unique patient identifier.

Upon receiving a valid reply from a second patient identification device 50, the transceiver 34 in the data collector 30 demodulates the first radio frequency signal, thereby extracting the patient identifier. The extracted patient identifier is stored in memory 36 along with the date and time of day that the reply was received. The data collector 30 also measures the signal interval during which the same patient identification device continues to reply to the data collector's signal. Occasionally, that data and the data collector's identifier are transferred as a patient event record from the data collector 30 to the patient records computer 12.

### Patient Monitoring

The present system is employed to monitor the medical condition of a patient within the medical facility. Medical personnel often observe bathroom activity of a patient as an indication of normal intestinal and other bodily functions. Thus when a patient goes to a bathroom, such as one connected to the patient's room, the data collector 30 within the bathroom receives the patient identifier from the identification device 24 worn by the patient. With reference to FIG. 5, each time the patient goes to the bathroom 47, the associated data collector 30 records the patient identifier received from the patient's wristband, the date and time of that visit, and the signal interval corresponding to the duration of the bathroom visit. As described above, each data collector 30 periodically transmits that acquired information along with its identifier to the patient records computer 12 in FIG. 1. As a consequence over the course of a day, the data records computer acquires data denoting every time that the patient visited a bathroom. This automated system does not require that nursing staff frequently observe the patient to monitor bathroom activity.

The patient records computer 12 then analyzes this data to produce a report indicating how many times the patient went to the bathroom, the frequency and duration of those visits, and the location of each bathroom 47 utilized. This information indicates the bodily activity of the patient, which is useful in determining the patient's recovery. For example, a patient going frequently to the restroom may indicate diarrhea, whereas a patient who does not visit the bathroom may be constipated or have renal problems. At any time that it is desired to review the status of a particular patient, nursing personnel can access the patient records computer 12 via one of the personal computers 16-18 and read a report of the information related to the bathroom activity.

Orthopedic and other patients often are prescribed an exercise regimen wherein they are to walk a certain amount of time around the halls 45 of the medical facility 49 depicted in FIG. 5. As the patient 60 walks beneath one of the data collectors 30 mounted on the ceiling of the hall 45, the patient identifier from the respective patient identification device 24 is transmitted by the first radio frequency signal to the data collector 30. That data collector records the patient identifier along with the date and time of day, and signal interval during which the first radio frequency signal is received. Periodically, each data collector 30 transfers this data along with the identification of that particular data collector to the patient records computer 12. Thus the movement of the patient throughout the medical facility is recorded by a plurality of patient event records sent by various data collectors 30 to the patient records computer 12.

As an option, the patient identification device 24 depicted in FIG. 3 may include an accelerometer 58 that detects force and directional movement of the patient in two or three axes and provides a signal indicative thereof to the control circuit 26. For example, FIG. 8 shows the type of signal waveform produced by the accelerometer 58 when the patient is walking. The signal indicates the number of steps taken, the rate of those steps and the general body motion that occurs during the walk. The shape of the pulses can denote a limp or other abnormal pattern in the patient's motion. Analysis of the accelerometer signal over several days or weeks can be performed to determine a patient's progress toward recovery from surgery, rehabilitation from an injury, or other response to medical treatment.

For example, when the patient 62 uses a particular piece of equipment in the medical facility, such as a treadmill 64 or other rehabilitation device, a data collector 31 adjacent that apparatus records the patient identifier along with the date and time of day, and signal interval during which the first radio frequency signal is received. This provides a record regarding the patient's use of that equipment. The signal from the accelerometer 58 also provides a measurement of the intensity of the patient's activity on the treadmill 64 or other apparatus.

Either when requested by medical personnel or at a predefined point in time, the patient records computer 12 analyzes all the patient event records for each patient to determine their motion throughout the medical facility. For example the analysis indicates where the patient traveled, how frequently the person went on a walk, and the time period of each walk. The signal intervals indicate whether the patient stopped to rest and for how long. Because data collectors 30 are placed at regular distances along the halls 45, the sequence of patient event records can be further analyzed to determine the distance traveled during each walk. The rate of patient activity is calculated from the fixed distance between data collectors 30 and the difference between the times in consecutive patient event records. This information is summarized in a report which is transmitted automatically to a particular personal computer 16 or 17 at the nursing station where the patient is being monitored. Alternatively, nursing personnel access the patient activity report by a query entered into a personal computer 16 or 17, which causes the report information to be transferred from the patient records computer 12.

In this manner, various reports about patient activity are provided to medical personnel for evaluation of the medical condition and recovery of the patient. That reporting does not require the direct observation of the patient's activity by medical personnel.

The patient monitoring also can be employed to locate non-ambulatory patients during an emergency situation in the medical facility. For example in case of a fire requiring evacuation of a portion of the facility, the personal computers 16, 17 or 18 can be used to query the computer system 10 to identify patients who still are in the building and where those patients are located. In addition a patient who becomes trapped in the building during the emergency also can be located even when that patient in outside his or her assigned room.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A method, for monitoring activity of a medical patient, comprising:
issuing an identification device to the patient wherein the identification device externally emits a first signal that provides a patient identification;
placing at least one data collector at a location frequented by the patient at which activity of the patient is desired to be monitored, wherein the data collector receives the first signal;
on a plurality of occasions when a given data collector receives the first signal, providing a separate patient event record; and
in response to a plurality of patient event records, preparing a report regarding activity of the patient.

2. The method as recited in claim 1 further comprising analyzing the report to evaluate a medical condition of the patient.

3. The method as recited in claim 1 wherein a data collector is provided at a location so that the first signal is received whenever the patient is present in a given room of a building.

4. The method as recited in claim 1 wherein a data collector is provided at a location so that the first signal is received whenever the patient uses a given piece of equipment.

5. The method as recited in claim 1 further comprising recording a date and time of day each time that the data collector receives first signal.

6. The method as recited in claim 5 wherein the report provides information when the patient performed a given activity.

7. The method as recited in claim 5 wherein preparing a report responds to the date and time of day so that the report provides information regarding a frequency that the patient performed a given activity.

8. The method as recited in claim 1 further comprising the data collector emitting a second signal, and wherein the identification device responds to receiving the second signal by emitting the first signal.

9. The method as recited in claim 1 further comprising incorporating a motion sensor into the identification device; and wherein in response to the motion sensor, the first signal provides an indication of patient motion.

10. (canceled)

11. The method as recited in claim 9 further comprising employing the indication of patient motion to determine a patient's response to medical treatment.

12. The method as recited in claim 9 further comprising employing the first signal to locate the patient.

13. A method for monitoring activity of a plurality of patients at a medical facility, said method comprising:
issuing a separate identification device to each patient, wherein each identification device emits a first wireless signal that provides a patient identifier;
placing a plurality of data collectors at different locations in the medical facility, wherein the data collector receives the first wireless signal;
providing a separate patient event record in response to one of the plurality of data collectors receiving the first wireless signal, wherein each patient event record contains the patient identifier, thereby over time providing a plurality of patient event records; and
deriving, from the plurality of patient event records, information about activity of each of the plurality of patients within the medical facility.

14. The method as recited in claim 13 further comprising utilizing the information about activity to evaluate a medical condition of one of the plurality of patients.

15. The method as recited in claim 13 wherein the information about activity includes a distance that one of the plurality of patients traveled.

16. The method as recited in claim 13 wherein the information about activity includes a rate at which one of the plurality of patients moved.

17. The method as recited in claim 13 wherein the information about activity indicates how many times one of the plurality of patients traveled from a room to which that one patient is assigned.

18. The method as recited in claim 13 wherein each patient event record contains a time of day each time that the first wireless signal was received by one of the plurality of data collectors.

19. The method as recited in claim 13 wherein the information about activity indicates a time of day.

20. The method as recited in claim 13 further comprising the information about activity indicates when the patient performed a given activity.

21. The method as recited in claim 13 wherein the information about activity of the patient indicates a frequency that the patient performed a given activity.

22. The method as recited in claim 13 wherein the patient event record includes an identification of the patient, a time of day when first wireless signal was received.

23. The method as recited in claim 22 wherein the patient event record further includes an identification of a particular one of the plurality of data collectors that received the first wireless signal.

24. The method as recited in claim 13 further comprising each of the plurality of data collectors emitting a second wireless signal, and wherein the identification device responds to receiving the second wireless signal by emitting the first wireless signal.

25. The method as recited in claim 13 further comprising incorporating a motion sensor into at least one identification device and wherein the first signal from that one identification device provides an indication of patient motion.

26. (canceled)

27. The method as recited in claim 25 further comprising employing the indication of patient motion to determine a patient's response to medical treatment.

28. (canceled)
